(19) United States
(12) Patent Application Publication
(10) Pub. No.: US 2008/0244036 A1
(43) Pub. Date: Oct. 2, 2008

(54) Regulation Compliance method for user-posted video files

(76) Inventors: Gregory A. Piccionelli, Westlake Village, CA (US); Michael M. Gerardi, Menifee, CA (US)

Correspondence Address: Michael M. Gerardi, Suite 200, 2801 Townsgate Road, Westlake Village, CA, 91361, US

(21) Appl. No.: 12/069,016

(22) Filed: Feb. 6, 2008

Related U.S. Application Data
(60) Provisional application No. 60/900,008, filed on Feb. 7, 2007.

(51) Int. Cl. G06F 15/16

(52) U.S. Cl. 709/217

(57) ABSTRACT

In a method of posting a video subject to a regulation on a website, the video being submitted to the website by a user, the user accesses a website that allows the user to post videos thereon. When it is determined that the video to posted on the website includes content subject to a regulation, the user provides information required by the regulation. A video segment that displays the information so provided is then produced and incorporated into the video, and the video incorporating the video segment is then enabled to be posted on the website.

This application is based on U.S. Provisional Patent Application Ser. No. 60/900,008, filed Feb. 7, 2007, the entire disclosure of which is incorporated herein by reference.

### FIELD OF THE INVENTION

The present invention relates to methods enabling users of websites that allow direct postings of video files by the users to submit, incorporate and display information required by applicable regulations to accompany such video files.

### BACKGROUND OF THE INVENTION

Many sites on networks, particularly wide-area networks such as the Internet, include subject matter which is intended for viewing by users over a certain age, for example age 18. Such sites typically pertain to content of an adult nature, such as gambling, liquor or tobacco sales, adult entertainment and the like. Such content is often subject to statutes and regulations requiring collection of information pertaining to the content's performers, producers, etc. Producers and distributors of such content may also be required to keep and/or display some or all of the collected information in various forms and at various times and locations. Exemplary statutes and regulations of this nature include 18 U.S.C. Sections 2257 and 2257a, and 28 C.F.R. 75 et seq. (“the 2257 regulations”) Under some regulatory regimes, such as the 2257 regulations, different requirements apply to producers of content and those who simply distribute content without taking actions, such as editing or otherwise modifying or controlling the content, which would render them content producers.

Recent developments in Internet technology enable users to access websites and post video or other files that they have produced. When such files include content subject to statutes and regulations as mentioned above, difficulties may arise in compliance, on the part both of the users and of those who maintain the websites. Users frequently are unaware of the need to comply with the statutes and regulations, or are unable or unwilling to do so. Website operators face difficulties in obtaining the required information. Website operators may also desire not to be considered producers of the content, but only distributors thereof, in order to simplify their compliance requirements.

Under certain statutes and regulations, once distributors of content obtain information that appears to be in compliance therewith, they are entitled to rely on that information without further investigation. For example, the 2257 regulations require distributors of sexually explicit content (i.e., “adult” content), such as website operators, to prepare compliance statements containing specific information and display them with the content in prescribed manners, but does not require the distributors to verify the accuracy of the information supplied by the producers of the content.

A need exists for a method that enables a user desiring to post content subject to regulations, such as the 2257 regulations, on a website to comply with the regulations applicable to such content.

A need also exists for a method that enables a website operator to allow users to post such content without the need for the operator to edit, modify or otherwise control the content and thus potentially become subject to regulations applicable to content producers rather than content distributors.

### SUMMARY OF THE PREFERRED EMBODIMENTS

In accordance with one aspect of the present invention, there is provided a method of posting a video subject to a regulation on a website, the video being provided to the website by a user. The method includes the steps of: accessing a website that allows the user to post videos thereon; determining if a video to be posted on the website includes content subject to a regulation; providing information required by the regulation when it is determined that the video includes such content; producing a video segment that displays the information so provided; incorporating the video segment into the video; and enabling the video incorporating the video segment to be posted on the website.

The video can be analyzed for the presence of content subject to a regulation in numerous ways. Thus, in one particular embodiment, the website presents the user with a query asking if the video includes content subject to the regulation. Such content can be, in a specific embodiment, sexually explicit content. In another particular embodiment, the video is analyzed using pattern-recognition software to determine if the video includes content subject to the regulation.

If content subject to a regulation is detected, then information required by the regulation may need to be supplied. According to a particular embodiment, therefore, the website advises the user that information required by the regulation must be provided prior to posting the video and directs the user to complete a form providing the required information. The user then completes the form, and thus provides the required information to the website.

Once any required information has been provided and a video segment containing the information is produced, in particular embodiments the video segment displays the information for a time sufficient to enable a viewer of the video to read the information. Alternatively, the video segment displays the information for a time and in a format prescribed by the regulation. The video segment displaying the information, in specific embodiments, is automatically produced by the website.

After the video segment is produced, the user, in particular embodiments, submits the video to the website. The video segment is then automatically incorporated into the video by the website. The video segment can be incorporated into the video in various ways according to specific embodiments of the inventive method. In one particular embodiment, the video segment is inserted before the beginning of the video submitted by the user. In another particular embodiment, the video segment is displayed in a box below a display of the video submitted by the user. The video segment beneficially is incorporated into the video in a manner prescribed by the regulation.

Upon incorporating the video segment into the video, the user, in certain particular embodiments, is provided with an opportunity to view and approve the video and the incorporated video segment.

Once the video segment has been produced and incorporated into the user's video, and the user has optionally been given an opportunity to approve the resultant combination, the video, including the incorporated video segment, is then posted on the website. Subsequent viewers desiring the view the posted video thus view a display of the incorporated video segment as well as the video, in accordance with the pertinent regulation.

It may happen that inaccurate, erroneous, or even fraudulent information is provided to the website upon request. In order to reduce the possibility of producing and incorporating a video segment including the unacceptable information, alternative embodiments of the inventive method compare the information provided by the to a database containing data known not to be associated with the production of video content to determine if any of the information so provided is included in the database. The user, in more specific embodiments, is advised that at least a portion of the information provided by the user is unacceptable when it is determined that such information is included in the database. The user is then, in very specific embodiments, given an opportunity to provide information to replace the information found to be unacceptable. Once acceptable information has been provided, the video segment production and incorporation process proceeds as above, and the video is posted on the website.

The foregoing methods for producing and posting videos that are in compliance with pertinent regulations can also be adapted to prevent the posting of videos that fail to comply with the regulations. Thus, in accordance with another aspect of the present invention, there is provided a method preventing the posting of a video subject to a regulation on a website, the video being provided to the website by a user. The method includes the steps of: accessing a website that allows the user to post videos thereon; determining if a video to be posted on the website includes content subject to a regulation; providing information required by the regulation when it is determined that the video includes such content; comparing the information so provided to a database containing data known not to be associated with the production of video content to determine if any of the information so provided is included in the database; and preventing the posting of the video when it is determined that any of the information so provided is included in the database.

To allow a user to correct possibly inadvertent or unintentional submissions of unacceptable information, particular embodiments advise the user that at least a portion of the information provided by the user is unacceptable when it is determined that such information is included in the database. The user, in further particular embodiments, is given an opportunity to provide information to replace the information found to be unacceptable, and the procedure then continues. If the replacement information is found to be acceptable, the posting procedure can then be implemented. If the replacement information remains unacceptable, one or more additional opportunities to submit acceptable information can be provided to the user, or alternatively, the procedure can terminate. The website then prevents posting of the video.

Other features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a flowchart illustrating an exemplary method according to the invention in which a user provides information required by regulation to be included with content to be posted on a website, and

FIG. 2 is a flowchart illustrating an alternative method according to the invention that includes screening of information provided by the user to eliminate obviously false information.

### DETAILED DESCRIPTION OF THE PREFERRED EMBODIMENTS

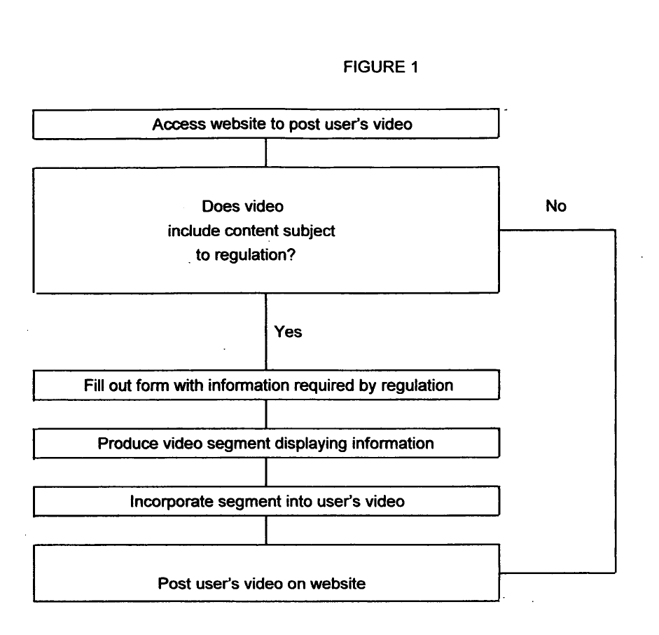

Turning now to the drawings, in FIG. 1 a user desiring to post a video on a website accesses the website. The website presents the user with a query asking if the video includes content subject to a regulation, such as the 2257 regulations.

If the answer is no, the video can be posted without the need for further information. Beneficially, a record of the user's answer is created. In the event that the video is determined to contain content subject to the regulation subsequent to its posting, the website will have a record of the user's erroneous or false answer, which may be of use to the website should the need arise for a defense against a charge, for example, of intentionally failing to comply with the regulation.

If the answer is yes, the user is advised that information required by the regulation must be provided prior to posting the video, and is directed to complete a form providing the required information. The user then completes the form. Should the user refuse or fail to provide the required information, the website denies posting the video.

The information provided by the user is then used to produce, typically by means of appropriate software or other automated means, a video segment that displays the information for a time sufficient to enable a viewer of the video to read the information, or alternatively, for a time and in a format prescribed by the applicable regulation. The user then submits the video to the website, and the video segment is incorporated into the video, again typically by means of appropriate software or other automated means. For example, the video segment can be inserted before the beginning of the user's video, so that the information is displayed prior to display of the content contained in the video. Alternatively, the video segment can be displayed in a box below a display of the user's video. Other methods of incorporating and/or displaying the information that may be required by the applicable regulation can also be implemented.

Once the video segment has been incorporated into the users video as discussed above, the user is optionally provided with an opportunity to view and approve the video and incorporated video segment. The user is then enabled, either automatically or by, for example, clicking on an appropriate button on a page displayed by the website, to post the video on the website. No actions on the part of individuals maintaining or operating the website are required, thus reducing or eliminating the possibility that website operators themselves may become subject to the regulation(s) applicable to the video and the user posting the video.

Subsequent viewers who access the website and view the user's video view the segment including the required information as well as the content supplied by the user.

According to an alternative embodiment, instead of asking the user whether the video includes content subject to the regulation, the user submits the video to the website for analysis. The video is then analyzed, for example by use of pattern-recognition software maintained by the website or another website, in order to determine if the video includes any content subject to the regulation. For example, the pattern-recognition software can search the video for explicit depictions of male and/or female genitalia or other explicit sexual activity. If it is determined that the video includes such content, the use is so advised, as with the preceding embodiments, and directed to submit the required information. Other applications capable of analyzing videos for the presence of selected images or patterns can also be used if desired.

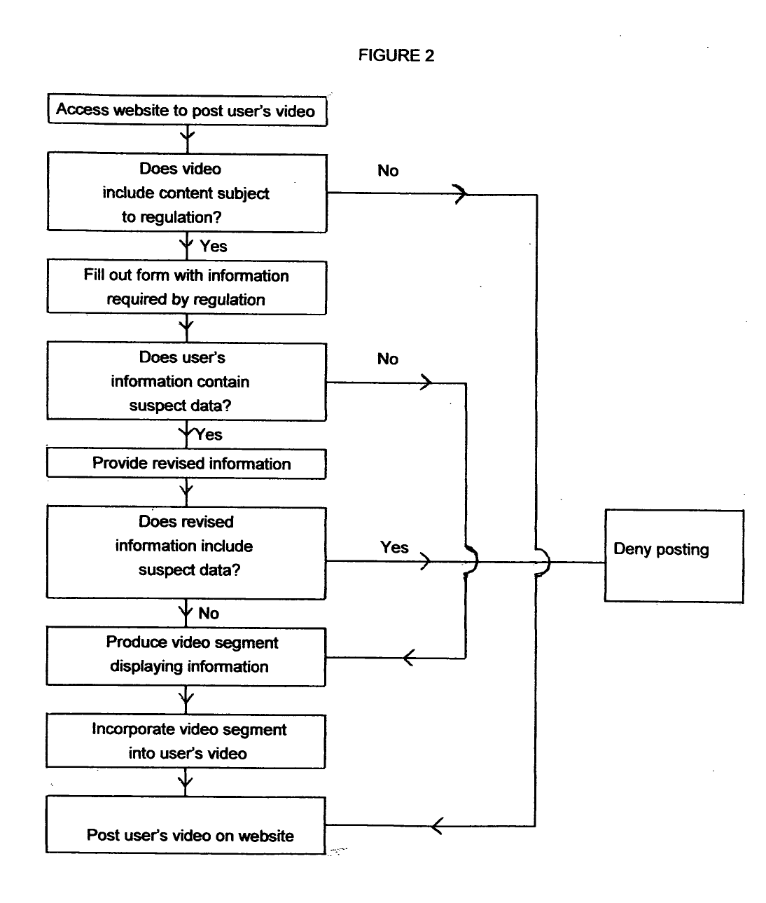

Although it may not be required according to some regulatory regimes, it may be desirable to filter out obviously fraudulent or otherwise inaccurate information provided by a user. For example, an unscrupulous user may provide a record custodian's address as 1600 Pennsylvania Avenue, Washington, D.C. Thus, alternative embodiments of methods according to the invention include a filtering step, as shown in FIG. 2. Information provided by the user is compared to a database containing suspect data, i.e., information known not to be associated with content production. If such information is provided, the user is advised that the information so provided is unacceptable and given at least one opportunity to provide acceptable information. Compliance results in production of the video segment and posting of the video as described above. Failure to do so results in refusal to post the user's video on the website.

Although the foregoing embodiments are directed to users supplying video files for posting on a website, other content formats, such as photographic files, can also be used and are considered to be within the scope of the invention.

What is claimed is:

1. A method of posting a video subject to a regulation on a website, the video being submitted to the website by a user, the method comprising the steps of:
a) accessing a website that allows the user to post videos thereon,
b) determining if a video to be posted on the website includes content subject to a regulation,
c) providing information required by the regulation when it is determined that the video includes said content,
d) producing a video segment that displays the information so provided,
e) incorporating the video segment into the video, and,
f) enabling the video incorporating the video segment to be posted on the website.

2. The method of claim 1 wherein in step (b) the website presents the user with a query asking if the video includes content subject to the regulation.

3. The method of claim 2 wherein the query asks if the video includes sexually explicit content.

4. The method of claim 1 wherein in step (b) the video is analyzed using pattern-recognition software to determine if the video includes content subject to the regulation.

5. The method of claim 1 wherein in step (c) the website advises the user that information required by the regulation must be provided prior to posting the video and directs the user to complete a form providing the required information.

6. The method of claim 5 wherein the user completes the form thereby providing the required information to the website.

7. The method of claim 1 wherein in step (d) the video segment displays the information for a time sufficient to enable a viewer of the video to read the information

8. The method of claim 1 wherein in step (d) the video segment displays the information for a time and in a format prescribed by the regulation.

9. The method of claim 1 wherein in step (d) the video segment is automatically produced by the website.

10. The method of claim 1 wherein in step (e) the user submits the video to the website and the video segment is automatically incorporated into the video by the website.

11. The method of claim 10 wherein the video segment is inserted before the beginning of the video submitted by the user.

12. The method of claim 10 wherein the video segment is displayed in a box below a display of the video submitted by the user.

13. The method of claim 10 wherein the video segment is incorporated into the video in a manner prescribed by the regulation.

14. The method of claim 1 wherein prior to step (f) the user is provided with an opportunity to view and approve the video and the incorporated video segment.

15. The method of claim 1 wherein information provided in step (c) is compared to a database containing data known not to be associated with the production of video content to determine if any of the information so provided is included in the database.

16. The method of claim 15 wherein the user is advised that at least a portion of the information provided by the user is unacceptable when it is determined that such information is included in the database.

17. The method of claim 16 wherein the user is given an opportunity to provide information according to step (c) to replace the information found to be unacceptable.

18. A method of preventing the posting of a video subject to a regulation on a website, the video being provided to the website by a user, the method comprising the steps of:
a) accessing a website that allows the user to post videos thereon,
b) determining if a video to be posted on the website includes content subject to a regulation,
c) providing information required by the regulation when it is determined that the video includes said content,
d) comparing the information provided in step (c) to a database containing data known not to be associated with the production of video content to determine if any of the information so provided is included in the database, and
e) preventing the posting of the video when it is determined that any of the information provided in step (c) is included in the database.

19. The method of claim 18 wherein the user is advised that at least a portion of the information provided by the user in step (c) is unacceptable when it is determined that such information is included in the database.

20. The method of claim 19 wherein the user is given an opportunity to provide information according to step (c) to replace the information found to be unacceptable.
